(19) United States
(12) Patent Application Publication
(10) Pub. No.: US 2024/0058760 A1
(43) Pub. Date: Feb. 22, 2024

(54) MULTI-STAGE VACUUM MEMBRANE DISTILLATION SYSTEM AND PROCESS

(71) Applicants: Saudi Arabian Oil Company, Dhahran (SA); King Fahd University of Petroleum & Minerals, Dhahran (SA)

(72) Inventors: Dahiru Umar Lawal, Dhahran (SA); Turki Nabieh Baroud, Dhahran (SA); Hasan Al Abdulgader, Dhahran (SA)

(21) Appl. No.: 17/892,347

(22) Filed: Aug. 22, 2022

(51) Int. Cl. B01D 61/36; B01D 69/02

(52) U.S. Cl. CPC B01D 61/3641; B01D 61/366; B01D 69/02; B01D 2313/243; B01D 2313/12; B01D 2313/26; B01D 2313/22; B01D 2317/04; B01D 2317/025; B01D 2325/38; B01D 2317/06; B01D 2313/54

(57) ABSTRACT

A multistage vacuum membrane distillation (MS-VMD) system including a plurality of modules is provided along with a method for using the MS-VMD. The MS-VMD system includes a feed chamber coupled to a feed line and a carrier gas line, wherein the feed line introduces a liquid feed into the feed chamber from a liquid feed tank, and wherein the carrier gas line introduces a carrier gas into the feed chamber. The MS-VMD system also includes a vacuum chamber coupled to a vacuum line, wherein the vacuum line pulls a vacuum on the vacuum chamber, and a membrane separating the feed chamber from the vacuum chamber, wherein the membrane allows transportation of vapor from the feed chamber to the vacuum chamber while blocking liquid from moving from the feed chamber to the vacuum chamber.

### TECHNICAL FIELD

The present disclosure is directed to a multi-stage vacuum membrane distillation system and process.

### BACKGROUND

Membrane distillation is a separation process that is driven by phase change. A membrane provides a barrier for a liquid phase while allowing a vapor phase to pass through. Membrane distillation can be used, for example, in water treatment. Several membrane distillation methods exist. Some examples include direct contact membrane distillation, air gap membrane distillation, vacuum membrane distillation, sweeping gas membrane distillation, vacuum multi-effect membrane distillation, and permeate gap membrane distillation.

The existing conventional membrane distillation systems are typically not efficient enough to be commercially feasible. Therefore, research has continued into the development of membrane distillation systems with a high rate of water permeate flux, reduced energy consumption, and efficient membrane fouling control.

### SUMMARY

In an embodiment described by example herein, a multistage vacuum membrane distillation (MS-VMD) system including a plurality of modules is provided. The MS-VMD system includes a feed chamber coupled to a feed line and a carrier gas line, wherein the feed line introduces a liquid feed into the feed chamber from a liquid feed tank, and wherein the carrier gas line introduces a carrier gas into the feed chamber. The MS-VMD system also includes a vacuum chamber coupled to a vacuum line, wherein the vacuum line pulls a vacuum on the vacuum chamber, and a membrane separating the feed chamber from the vacuum chamber, wherein the membrane allows transportation of vapor from the feed chamber to the vacuum chamber while blocking liquid from moving from the feed chamber to the vacuum chamber.

Another embodiment described by example herein provides a method for purifying a liquid using a multi-stage vacuum membrane distillation (MS-VMD) system. The method includes feeding a liquid to a feed chamber in each of a plurality of modules, wherein the liquid in the feed chamber is at a temperature of greater than about 50° C. A carrier gas is fed through the liquid in the feed chamber of each of the plurality of modules to form humidified carrier gas. A vacuum is pulled on a vacuum chamber in each of the plurality of modules through a vacuum line, wherein the vacuum chamber in each module is separated from the feed chamber in each module by a membrane, and wherein the membrane allows vapor to pass across the membrane while blocking liquid flow across the membrane. A purified liquid is condensed from the vacuum line. The purified liquid is condensed from the humidified carrier gas.

### BRIEF DESCRIPTION OF DRAWINGS

FIG. 1A is a simplified process flow diagram of a multi-stage vacuum membrane distillation (MS-VMD) system including a number of modules, in which each of the modules is fluidly connected in parallel to a feed line, a carrier gas line, and a vacuum line.

FIG. 1B is a simplified process flow diagram a MS-VMD system that uses the condenser for the vapor from the vacuum line and a carrier gas condenser for the gas from the carrier gas outlet line, wherein the modules are connected in parallel to the feed line, the feed return line, the carrier gas line, the carrier gas outlet line, and the vacuum line.

FIG. 1C is a simplified process flow diagram of a MS-VMD that uses the condenser for the vapor from the vacuum line and the gas from the carrier gas outlet line, wherein the feed chamber of each of the modules are connected in parallel to the feed line, the feed return line, the carrier gas line, and the carrier gas outlet line, and in series with the vacuum line.

FIG. 1D is a simplified process flow diagram of a MS-VMD system that uses the condenser for the vapor from the vacuum line and the carrier gas condenser for the gas from the carrier gas outlet line, wherein the feed chamber of each of the modules are connected in parallel to the feed line, the feed return line, the carrier gas line, and the carrier gas outlet line, and in series with the vacuum line.

FIG. 1E is a simplified process flow diagram of a MS-VMD system that uses the condenser for the vapor from the vacuum line and the gas from the carrier gas outlet line, wherein the modules are coupled in parallel to the feed line, the feed return line, and the vacuum line, but are coupled in series to the carrier gas line.

FIG. 1F is a simplified process flow diagram of a MS-VMD system that uses the condenser for the vapor from the vacuum line and the carrier gas condenser for the gas from the carrier gas outlet line, wherein the modules are coupled in parallel to the feed line, the feed return line, and the vacuum line, but are coupled in series to the carrier gas line.

FIG. 1G is a simplified process flow diagram a MS-VMD system that uses the condenser for the vapor from the vacuum line and the gas from the carrier gas outlet line, wherein the modules are coupled in parallel to the feed line and the feed return line, but are coupled in series to the carrier gas line and the vacuum line.

FIG. 1H is a simplified process flow diagram of a MS-VMD system that uses the condenser for the vapor from the vacuum line and the carrier gas condenser for the gas from the carrier gas outlet line, wherein the modules are coupled in parallel to the feed line and the feed return line, but are coupled in series to the carrier gas line and the vacuum line.

FIG. 1I is a simplified process flow diagram of a MS-VMD system that uses the condenser for the vapor from the vacuum line and the gas from the carrier gas outlet, wherein the modules are coupled in parallel to the carrier gas line and the vacuum line, but are coupled in series to the feed line.

FIG. 1J is a simplified process flow diagram of a MS-VMD system that uses the condenser for the vapor from the vacuum line and the carrier gas condenser for the gas from the carrier gas outlet line, wherein the modules are coupled in parallel to the carrier gas line and the vacuum line, but are coupled in series to the feed line.

FIG. 1K is a simplified process flow diagram of a MS-VMD system that uses the condenser for the vapor from the vacuum line and the gas from the carrier gas outlet line, wherein the wherein the modules are coupled in parallel to the carrier gas line, but are coupled in series to the feed line and the vacuum line.

FIG. 1L is a simplified process flow diagram of a MS-VMD system that that uses the condenser for the vapor from the vacuum line and the carrier gas condenser for the gas from the carrier gas outlet line, wherein the modules are coupled in parallel to the carrier gas line, but are coupled in series to the feed line and the vacuum line.

FIG. 1M is a simplified process flow diagram of a MS-VMD system that that uses the condenser for the vapor from the vacuum line and the gas from the carrier gas outlet line, wherein the modules are coupled in parallel to the vacuum line, but are coupled in series to the carrier gas line and the feed line.

FIG. 1N is a simplified process flow diagram of a MS-VMD system that that uses the condenser for the vapor from the vacuum line and the carrier gas condenser for the gas from the carrier gas outlet line, wherein the modules are coupled in parallel to the vacuum line, but are coupled in series to the carrier gas line and the feed line.

FIG. 1O is a simplified process flow diagram of a MS-VMD system that that uses the condenser for the vapor from the vacuum line and the gas from the carrier gas outlet line, wherein the modules are coupled in series to the vacuum line, the carrier gas line, and the feed line.

FIG. 1P is a simplified process flow diagram of a MS-VMD system that that uses the condenser for the vapor from the vacuum line and the carrier gas condenser for the gas from the carrier gas outlet line, wherein the modules are coupled in series to the vacuum line, the carrier gas line, and the feed line.

FIG. 2 is a process flow diagram of a method for purifying a liquid feed using a MS-VMD system.

### DETAILED DESCRIPTION

Membrane distillation (MD) is a combined thermal and membrane-based separation process, which allows vapor to permeate across a membrane while preventing liquid from crossing the membrane. The MD separation process is commonly applied in water desalination by separating water vapor from a brine stream using a micro- or nano-porous membrane, depending on the pore size desired. The feed liquid fed to the feed side of the MD is usually heated to encourage evaporation, while the temperature of the coolant stream received by the coolant side of the MD is usually kept lower than that of the feed stream temperature to encourage condensation. The driving force for water vapor permeation across the membrane is the vapor pressure difference. The vapor pressure difference is often induced by the temperature gradient across the membrane. Membrane distillation can be performed at a low feed temperature, for example, less than 100° C. The low operating temperatures allow membrane distillation to be operated using renewable energy and low-grade energy sources, such as solar energy, wind energy, geothermal energy, and waste heat.

Four types of membrane distillation configurations include sweeping gas membrane distillation (SGMD), vacuum membrane distillation (VMD), direct contact membrane distillation (DCMD) and air gap membrane distillation (AGMD). These MD configurations operate on the same principle, for example, vapor generation, vapor permeation across membrane, and vapor. The differences among these configurations lie in the design of the condensation chambers, while the feed chambers of the modules typically remain the same for all configurations. While direct contact membrane distillation system yields high permeate flux, it also has high conductive heat loss and high temperature polarization effects. Further, permeate contamination is possible in DCMD. AGMD is characterized by low conductive heat loss and low temperature polarization effect. However, AGMD yields low permeate flux from resistance to mass transfer in the air in the distillate chamber. Permeate gap membrane distillation (PGMD) has a higher permeate flux than AGMD. PGMD is sometimes referred to as liquid gap membrane distillation (LGMD) or water gap membrane distillation (WGMD). In PGMD, the stagnant air in the distillate chamber of an AGMD is replaced with a liquid, such as distilled water or deionized water. In PGMD, vapor from the feed stream permeates across the membrane pores and condenses at the interface between the permeate side of the membrane and the water in the distillate zone.

A multi-stage vacuum membrane distillation (MS-VMD) system and a process for using the MS-VMD are provided herein. The MS-VMD system includes multiple cells or modules. Each of the modules includes a feed chamber in which a liquid to be treated is fed, and a vacuum chamber in which a vacuum is pulled. A vapor permeable, liquid impervious membrane separates the chambers. The membrane allows a component of the liquid to pass in the form of vapor. A carrier gas is bubbled, and humidified, through the feed chamber of each of the modules and is condensed in an external condenser outside of the module, producing a purified liquid and a concentrated feed solution.

Flowing a carrier gas through the liquid in the feed chamber of each module increases the mass transfer coefficient from the feed chamber of the module by increasing the turbulent dissipation rate in the liquid, which improves the rate of vapor permeation. Further, the carrier gas is humidified and becomes saturated with water vapor after bubbling through the liquid in the feed chamber. In some embodiments, the humidified carrier gas is connected to an external condenser used for condensing vapor from the vacuum chambers, or is condensed in a separate condenser, which may increase the productivity of the MS-VMD process. Coupling the line carrying the humidified carrier gas line to the external condenser to which the vacuum line is coupled will also apply vacuum on the feed chambers, enhancing the evaporation rate in the feed chambers and improve the energy and productivity of the MS-VMD system. Further, bubbling the carrier gas through the feed chambers may detach scaling or fouling on the surface or in the pores of the membrane material, thereby reducing the amount of membrane fouling or scaling, and lowering the operating costs due to replacing membranes or modules,

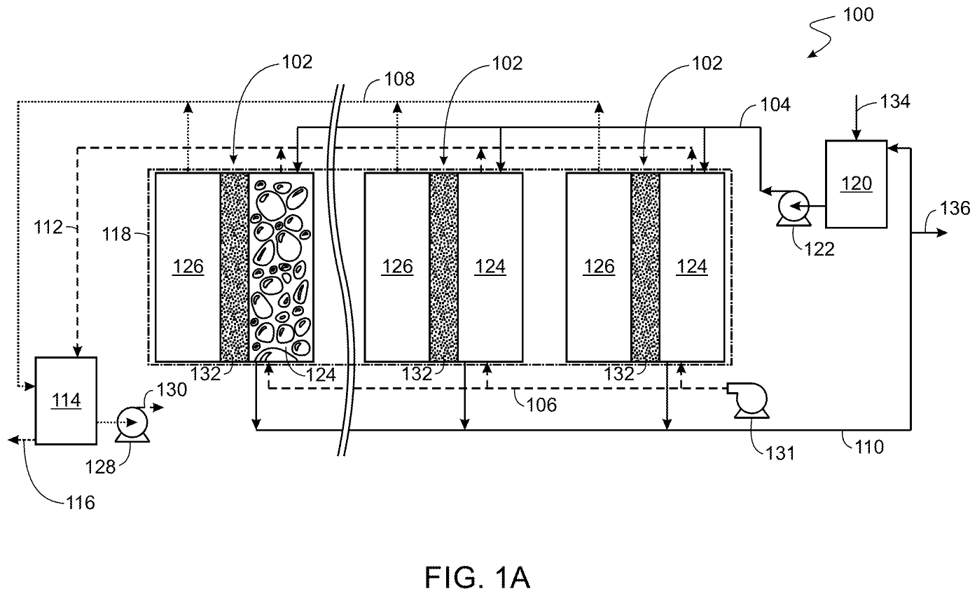

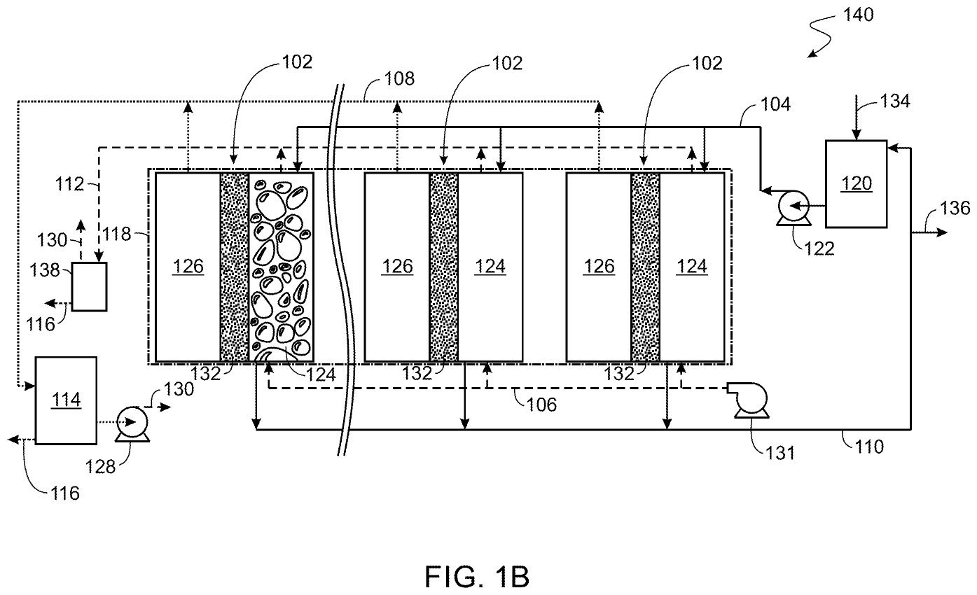

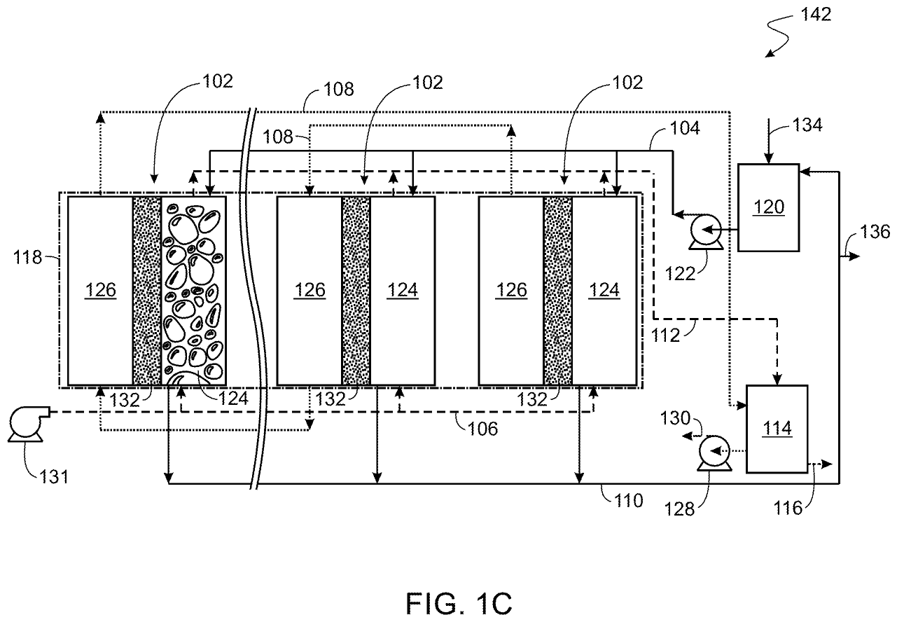

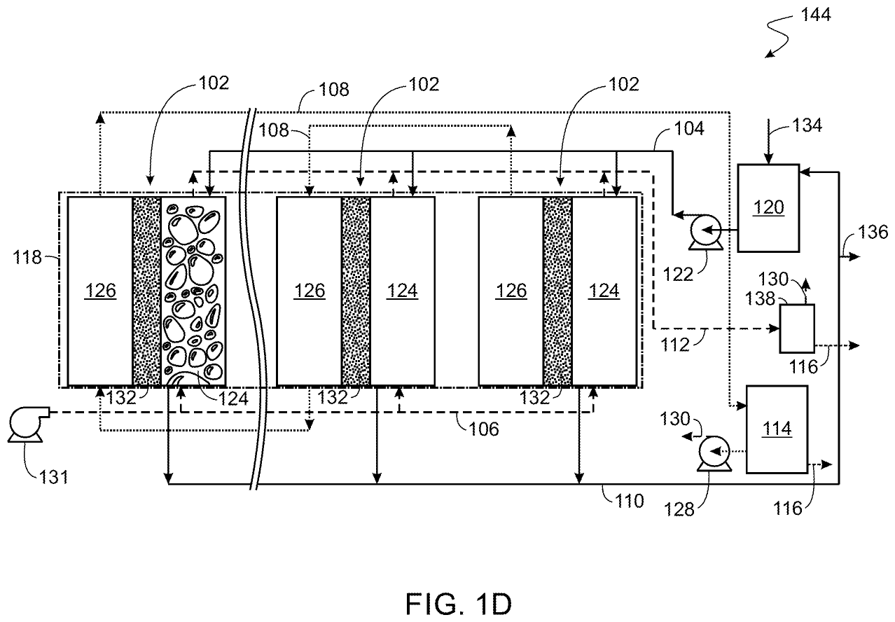

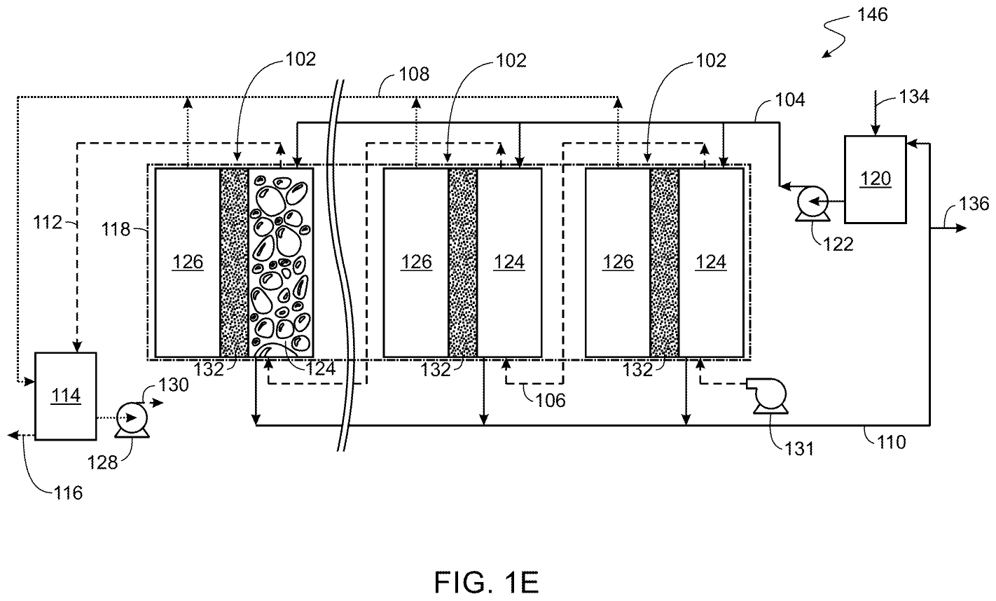

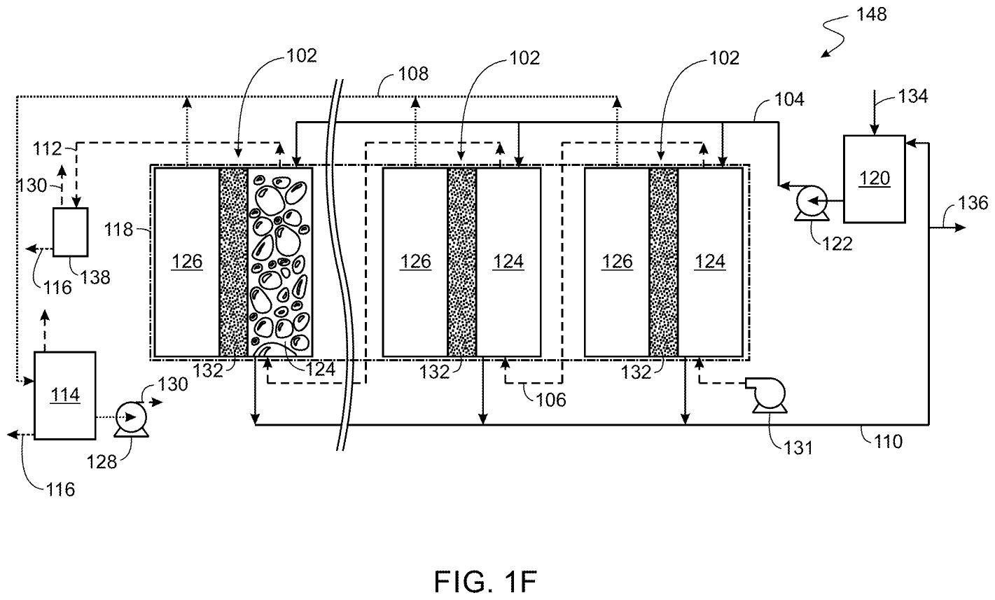

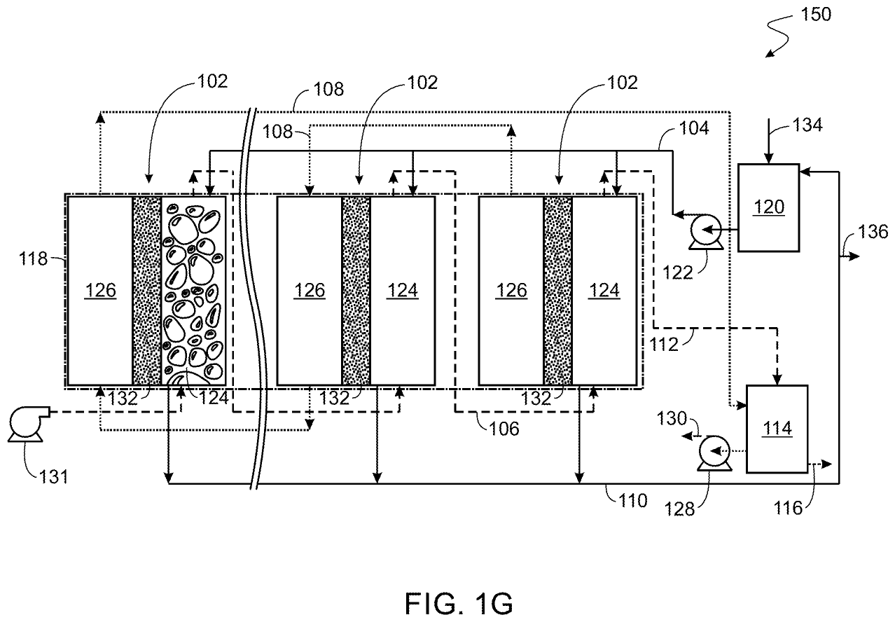

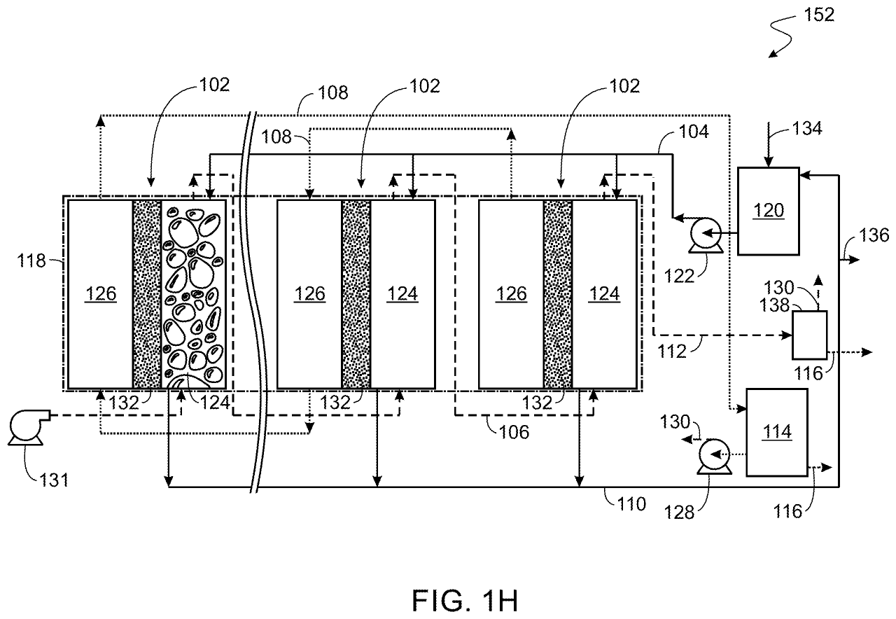

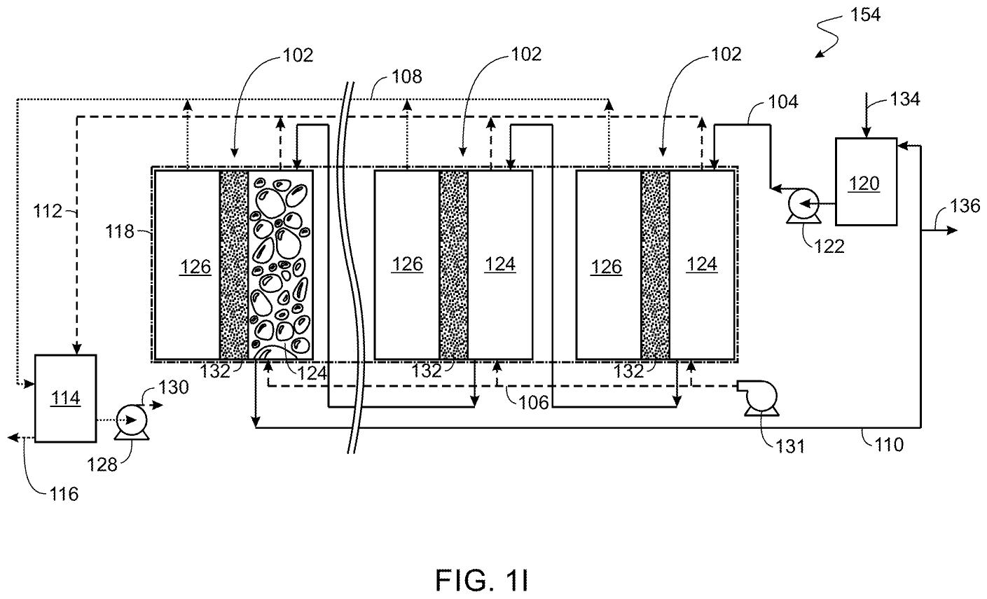

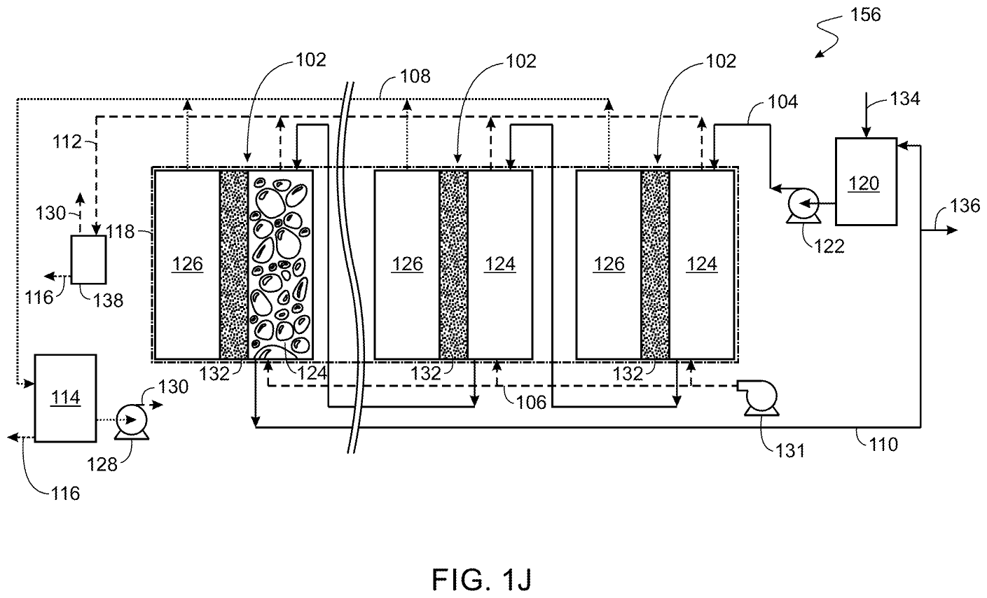

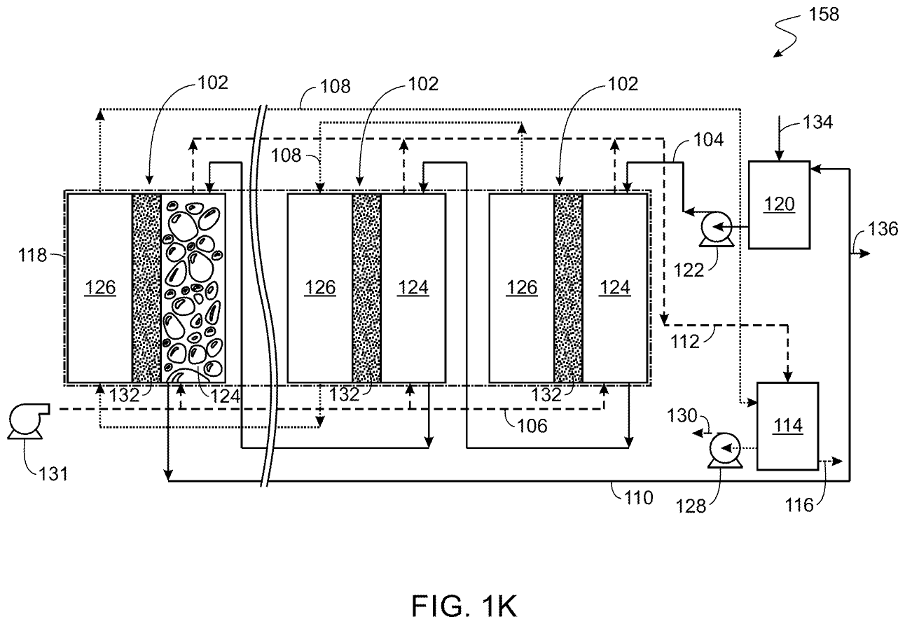

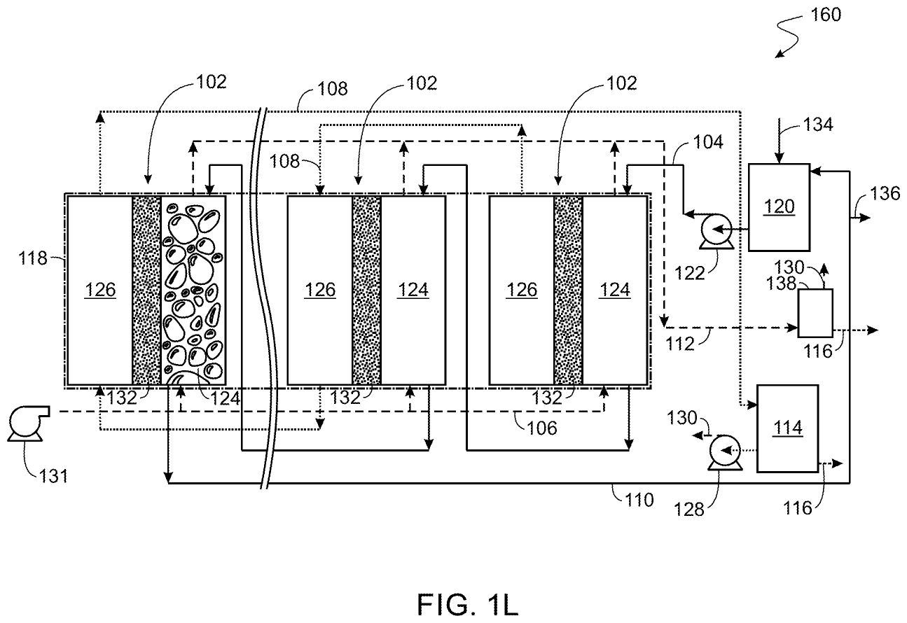

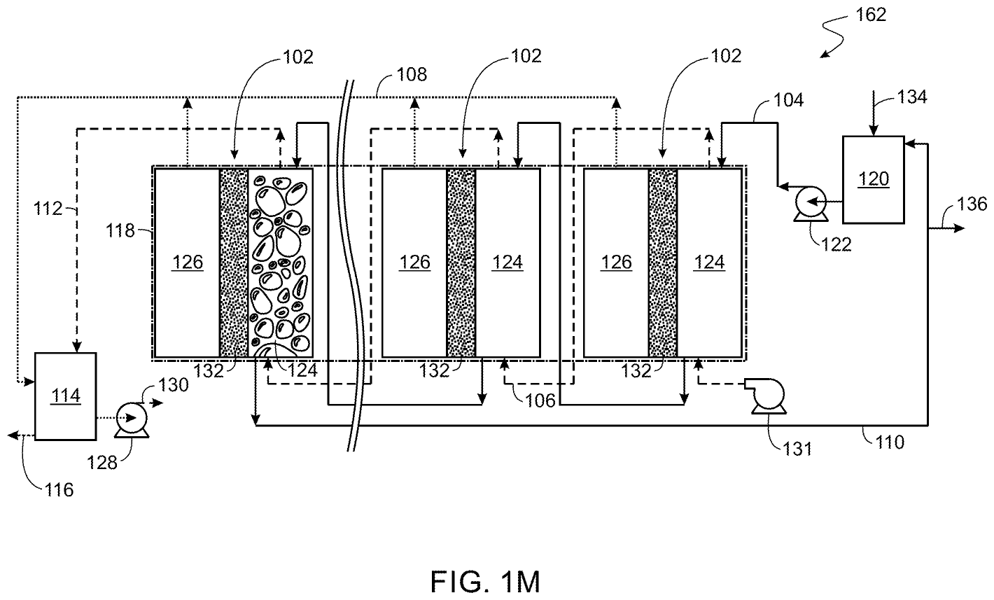

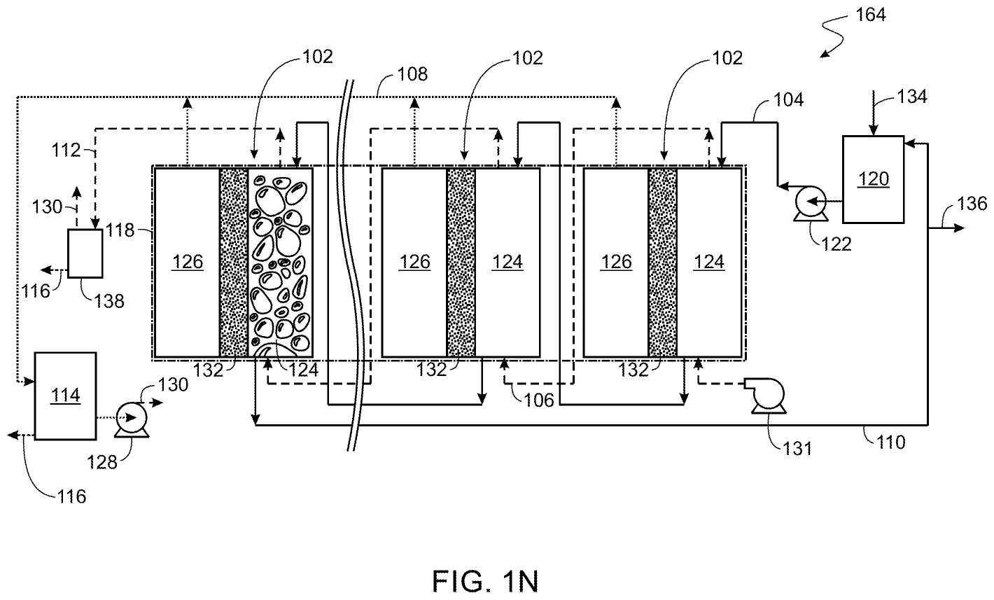

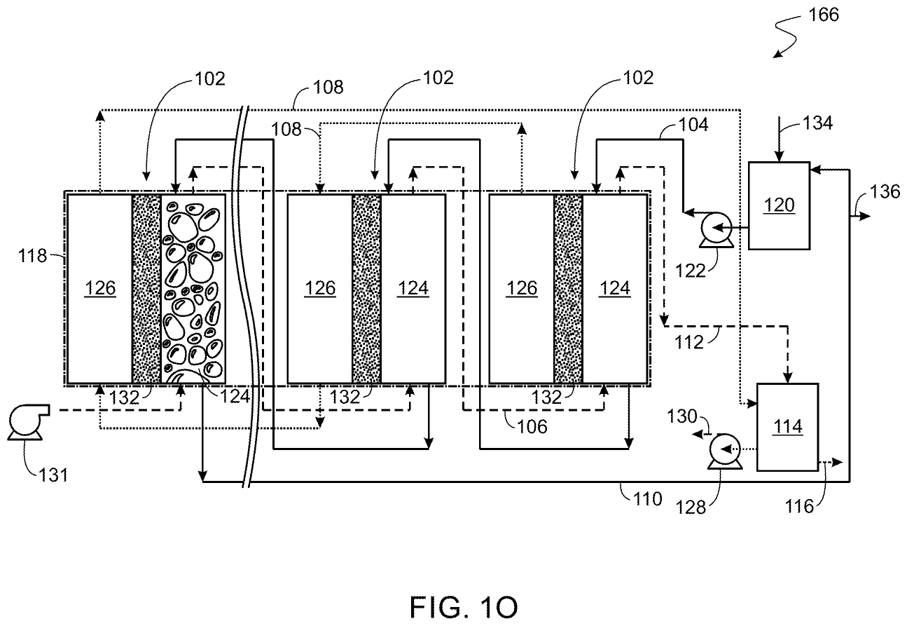

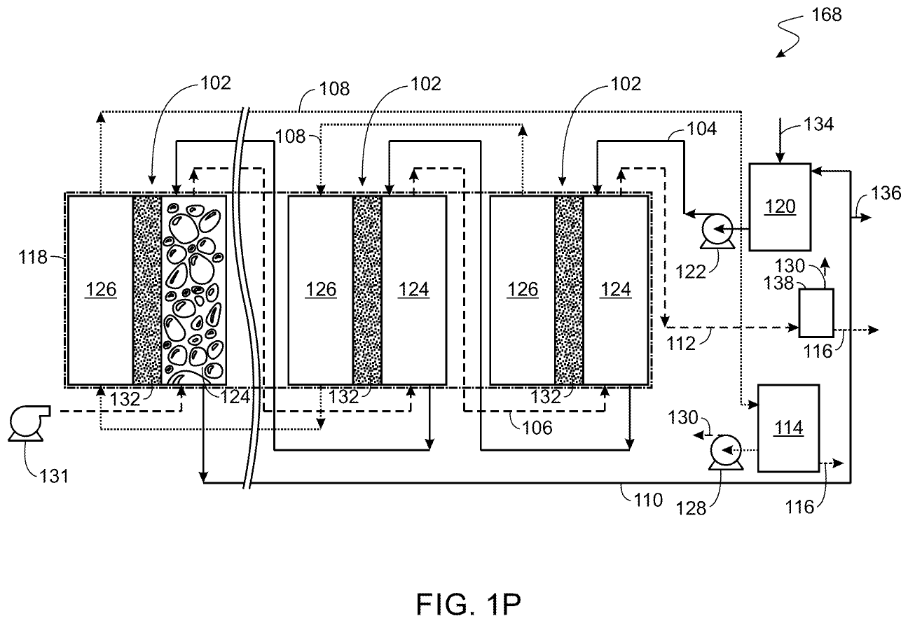

FIG. 1A is a simplified process flow diagram of a MS-VMD system 100 including a number of modules 102, in which each of the modules 102 is fluidly connected in parallel to a feed line 104, a carrier gas line 106, and a vacuum line 108. Each of the modules 102 are also connected in parallel to a feed return line 110 and a carrier gas outlet line 112. In this embodiment, a single external condenser 114 is used to condense a fluid from the vapor flow in the vacuum line 108 and the carrier gas outlet line 112. The fluid, such as purified water, is removed from the MS-VMD system 100 through a distillate outlet 116. In the embodiment shown in FIG. 1A, the modules 102 are contained in a housing 118. In other embodiments, the modules 102 may be stand-alone units in individual housings. In some embodiments, a base set of modules 102 are enclosed in the housing 118, and additional modules 102 in individual housings are added to increase the capacity of the MS-VMD system 100.

The feed line 104 provides a liquid feed to each of the modules 102 from a liquid feed tank 120, for example, by a pump 122. In some embodiments, the liquid feed tank 120 is heated, for example, by a heating element in the liquid feed tank 120 or by a heat exchanger on the feed line 104, to provide a hot liquid feed in the feed line 104. In other embodiments, a heating element is inserted inside the feed chamber 124 of each module 102. A combination of both heating methods can be used. The temperature of the liquid feed is generally less than about 100° C., or less than about 75° C., or less than about 60° C., or between about 40° C. and about 60° C., or about 50° C. The temperature used may be selected based on the configuration of the modules, as described herein. Modules in which the feed is fluidically coupled in series may use a higher temperature in earlier modules in the series to reduce the need for heating later modules in the series.

In some embodiments, the feed liquid in the feed chamber 124 is statically processed by filling and closing valves on the inlet points from the feed line 104 and outlet points from the feed chamber 124 to the feed return line 110. Alternatively, the feed liquid can be dynamically added to the feed chamber 124 from the feed line 104 under the flow of gravity by mounting of the liquid feed tank 120 higher than the modules 102, then partially opening the inlet points from the feed line 104 and outlet points from the feed chamber 124 to the feed return line 110. As mentioned herein, the feed liquid can also be pumped through the feed chamber 124 using a pump 122. In some embodiments, the pump 122 is variable and a control system is used to reach a desired flowrate, for example, sufficient to keep the feed chamber 124 liquid full.

The feed liquid provided from the liquid feed tank 120 can be an aqueous solution, for example, seawater, industrial wastewater, brackish water, produced water, fruit juice, blood, milk, dye, hazardous waste water, brine solution, non-condensable gas, non-potable water, or any liquid including a dissolved salt, for example, a mixture of salts, a salt and organic contaminant mixture, a salt and inorganic contaminant mixture, or a combination of these.

The vacuum line 108 is coupled to a vacuum chamber 126 in each of the modules 102. The vacuum on the vacuum line 108 is provided by a vacuum pump 128, or other device on the condenser 114, such as a compressor, and other devices, which can create vacuum or low pressure. The condenser 114 itself will create some vacuum by condensing the distillate outlet 116 from the vapor in the vacuum line 108 and the humidified gas in the carrier gas outlet line 112. The vacuum pump 128 vents noncondensable gases through a vent line 130, such as the carrier gas from the carrier gas outlet line 112. The carrier gas may be nitrogen, air, helium, argon, carbon dioxide, and the like. In some embodiments, different carrier gases may be used in different modules 102. For example, compressed air may be used in upstream modules 102, while dry air is used in modules 102 that are downstream to increase the removal of water.

The carrier gas can be supplied to the carrier gas line 106 from a device such as a blower 131, compressor, gas tank, gas line, or the like. After exiting through the vent line 130, the carrier gas may be recycled in the process, for example, by being passed through a dryer and returned to the blower 131. The carrier gas may be injected to the feed chamber 124 at ambient conditions or may be heated prior to injection to feed chamber 124. In various embodiments, the injection into the feed chamber 124 is from a single point injector or a multiple point injector, such as a sparger or orifice coupled to the carrier gas line 106.

As described herein, the heat source for the MS-VMD system 100 can be from renewable energy sources, low-grade energy sources, electrical energy, waste heat from other thermal processes, or their combinations. As described herein, the heat can be applied to the liquid in the liquid feed tank 120, to a heater in the feed chamber 124, or both.

The feed chamber 124 is separated from the vacuum chamber 126 by a membrane 132. In various embodiments, the membrane 132 in each of the modules 102 is a reinforced hollow tube, a non-reinforced hollow tube, a spiral wound tube, a flat sheet, or a non-flat sheet. The membrane 132 includes multiple pores that are sized to allow water vapor originating from the hot liquid to pass from the feed chamber 124 through the membrane 132 to the vacuum chamber 126. The membrane 132 prevents liquid flow between the feed chamber 124 and the vacuum chamber 126.

In various embodiments, the membrane 132 is a composite membrane, a nano-composite membrane, a hydrophobic membrane, an omniphobic membrane, a hydrophilic and hydrophobic composite dual layer membrane, a modified ceramic membrane, a porous ceramic membrane, a surface modified membrane, a polymer electrolyte membrane, a porous graphene membrane, or a polymeric membrane. In some implementations, the membrane 132 includes a support layer and an active layer. The membrane 132 can be made, for example, from a porous material, such as a ceramic. In some implementations, a contact angle of a droplet of the liquid on the membrane 132 is greater than 90 degrees (°). In some embodiments, a different material is be used for the membrane 132 in different modules 102. For example, for modules coupled in series, the membrane 132 used in modules 102 that are upstream may have smaller effective pore sizes as more vapor may be released from more dilute liquid, while downstream modules 102 may have larger effective pore sizes as the more concentrated liquid may release less vapor.

As described herein, the vacuum chamber 126 is coupled to the vacuum line 108, which pulls the water vapor from the vacuum chamber 126 to the condenser 114. As the water vapor from the vacuum line 108 and the water vapor in the gas from the carrier gas outlet line 112 are condensed to form the water in the distillate outlet 116, additional liquid is added to the liquid feed tank 120 through a make-up line 134. As the liquid feed is concentrated in the process, it may reach a point at which it is too concentrated for effective separation. Accordingly, a portion of the liquid feed may be removed from a drain line 136, for example, coupled to the feed return line 110, to allow dilution of the liquid feed with fresh liquid added through the make-up line 134.

In some embodiments, the condenser 114 includes thin metallic tubes or thin polymeric tubes. The condenser 114 can be made, for example, from a metallic material, a composite material, or carbon fibers, among others. As described herein, the condensed water from the condenser 114 is removed through the distillate outlet 116. The water from the distillate outlet 116 has a water purity level that is greater than a water purity level of the liquid feed from the liquid feed tank 120.

The modules 102, including the chambers 124 and 126 and the membrane 132, of the MS-VMD system 100 may be of any shape, such as rectangular, triangular, square, circular, cylindrical, hexagonal, or spherical. The housing 118 can be made, for example, from metallic material, polymeric material, composite material, carbon fiber, carbon nanotubes, and the like. In some implementations, the housing 118 is made of steel, brass, copper, high-density polyethylene (HDPE), acrylic, or polyvinyl chloride (PVC).

In some implementations, the housing 118 includes a frame, support, gasket, or a combination of these, which can provide structural support, form the chambers 124 and 126 of the modules 102, and hold the membrane 132 between the chambers 124 and 126. The supporting structure can be made of a material that is non-corrosive and chemically inert in relation to the liquid feed.

As described herein, the MS-VMD system 100 removes water as vapor from the liquid feed using two different processes. Water vapor is entrained in the carrier gas after it is bubbled through the liquid feed in the feed chamber 124, at least partially saturated the carrier gas. Further, water vapor is transported across the membrane pores from the feed chamber 124 to the vacuum chamber 126, and pulled from the vacuum chamber 126 out through the vacuum line 108. The driving force for mass/vapor transfer across the pores of the membranes is the partial pressure difference across the membrane 132, and thus, the vacuum increases the partial pressure difference and increases the mass/vapor transfer.

The MS-VMD system 100 is not limited to the configuration shown in FIG. 1A. In other configurations, separate condensers are used for the gas from the carrier gas outlet line 112 and the vacuum line 108. In addition to this, in various embodiments, the modules 102 are connected in series to one or more of the lines used for fluid flow through the modules 102, such as the feed line 104 and feed return line 110, the carrier gas line 106 and the carrier gas outlet 112, and the vacuum line 108. These configurations are discussed with respect to FIGS. 1B-1P.

FIG. 1B is a simplified process flow diagram a MS-VMD system 140 that uses the condenser 114 for the vapor from the vacuum line 108 and a carrier gas condenser 138 for the gas from the carrier gas outlet line 112, wherein the modules 102 are connected in parallel to the feed line 104, the feed return line 110, the carrier gas line 106, the carrier gas outlet line 112, and the vacuum line 108.

In this embodiment, the carrier gas line 106, and the carrier gas outlet line 112, and the vacuum line 108 are all coupled to the modules 102 in parallel. Depending on the amount of water vapor in the vapor from the vacuum line 108 and the gas from the carrier gas outlet line 112, this arrangement may increase capacity over a single condenser.

FIG. 1C is a simplified process flow diagram of a MS-VMD 142 that uses the condenser 114 for the vapor from the vacuum line 108 and the gas from the carrier gas outlet line 112, wherein each of the modules 102 are connected in parallel to the feed line 104, the feed return line 110, the carrier gas line 106, and the carrier gas outlet line 112, and in series with the vacuum line 108.

In this embodiment, the vacuum line 108 is coupled to each vacuum chamber 126 through a first port, then to the next vacuum chamber through a second port. The last vacuum chamber 126 in the series is coupled to the condenser 114.

FIG. 1D is a simplified process flow diagram of a MS-VMD system 144 that uses the condenser 114 for the vapor from the vacuum line 108 and the carrier gas condenser 138 for the gas from the carrier gas outlet line 112, wherein each of the modules 102 are connected in parallel to the feed line 104, the feed return line 110, the carrier gas line 106, and the carrier gas outlet line 112, and in series with the vacuum line 108.

In this embodiment, the vacuum line 108 is coupled to each vacuum chamber 126 through a first port, then to the next vacuum chamber through a second port. The last vacuum chamber 126 in the series is coupled to the condenser 114.

FIG. 1E is a simplified process flow diagram of a MS-VMD system 146 that uses the condenser 114 for the vapor from the vacuum line 108 and the gas from the carrier gas outlet line 112, wherein the modules 102 are coupled in parallel to the feed line 104, the feed return line 110, and the vacuum line 108, but are coupled in series to the carrier gas line 106.

In this embodiment, the carrier gas line 106 from the blower 131 is coupled to an inlet on the feed chamber 124 of the first module 102 downstream of the blower 131. Each of the modules 102 downstream of the first module 102 has a carrier gas line 106 coupled to an inlet of the module 102 that is coupled to an outlet of the preceding module 102. The carrier gas outlet line 112 from the feed chamber 124 of the last of the modules 102 in the series is coupled to the condenser 114.

FIG. 1F is a simplified process flow diagram of a MS-VMD system 148 that uses the condenser 114 for the vapor from the vacuum line 108 and the carrier gas condenser 138 for the gas from the carrier gas outlet line 112, wherein the modules 102 are coupled in parallel to the feed line 104, the feed return line 110, and the vacuum line 108, but are coupled in series to the carrier gas line 106.

In this embodiment, the carrier gas line 106 from the blower 131 is coupled to an inlet on the feed chamber 124 of the first module 102 downstream of the blower 131. Each of the modules 102 downstream of that has a carrier gas line 106 coupled to an inlet of the module 102 that is coupled to an outlet of the preceding module 102. The carrier gas outlet line 112 from the feed chamber 124 of the last of the modules 102 in the sequence is coupled to the carrier gas condenser 138. As described with respect to FIG. 1D, this arrangement may increase capacity over a single condenser.

FIG. 1G is a simplified process flow diagram a MS-VMD system 150 that uses the condenser 114 for the vapor from the vacuum line 108 and the gas from the carrier gas outlet line 112, wherein the modules 102 are coupled in parallel to the feed line 104 and the feed return line 110, but are coupled in series to the carrier gas line 106 and the vacuum line 108. In this embodiment, the carrier gas line 106 from the blower 131 is coupled to an inlet on the feed chamber 124 of the first module 102 downstream of the blower 131. Each of the modules 102 downstream of that has a carrier gas line 106 coupled to an inlet of the module 102 that is coupled to an outlet of the preceding module 102. The carrier gas outlet line 112 from the feed chamber 124 of the last of the modules 102 in the sequence is coupled to the condenser 114. Further, the vacuum line 108 is coupled to each vacuum chamber 126 through a first port, then to the next vacuum chamber through a second port. The last vacuum chamber 126 in the series is coupled to the condenser 114. The series connection for both the carrier gas line 106 and the vacuum line 108 may increase the amount of water vapor removed from the liquid feed, increasing the efficiency of the MS-VMD system 150.

FIG. 1H is a simplified process flow diagram of a MS-VMD system 152 that uses the condenser 114 for the vapor from the vacuum line 108 and the carrier gas condenser 138 for the gas from the carrier gas outlet line 112, wherein the modules 102 are coupled in parallel to the feed line 104 and the feed return line 110, but are coupled in series to the carrier gas line 106 and the vacuum line 108.

In this embodiment, the carrier gas line 106 from the blower 131 is coupled to an inlet on the feed chamber 124 of the first module 102 downstream of the blower 131. Each of the modules 102 downstream of that has a carrier gas line 106 coupled to an inlet of the feed chamber 124 of the module 102 that is coupled to an outlet of the feed chamber 124 of the preceding module 102. The carrier gas outlet line 112 from the feed chamber 124 of the last of the modules 102 in the sequence is coupled to the carrier gas condenser 138. Further, the vacuum line 108 is coupled to each vacuum chamber 126 through a first port, then to the next vacuum chamber through a second port. The last vacuum chamber 126 in the series is coupled to the condenser 114.

As described herein, the use of two condensers 114 and 138 may increase the capacity over a single condenser 114. Further, if the series coupling of the carrier gas line 106 requires higher pressure, and thus, flow rate, using the carrier gas condenser 138 may decrease the risk of cross-contamination from any entrained droplets carried from the liquid feed.

FIG. 1I is a simplified process flow diagram of a MS-VMD system 154 that uses the condenser 114 for the vapor from the vacuum line 108 and the gas from the carrier gas outlet 112, wherein the modules 102 are coupled in parallel to the carrier gas line 106 and the vacuum line 108, but are coupled in series to the feed line 104. In this embodiment, the feed line 104 is coupled to an inlet on the feed chamber 124 for the first module 102 downstream of the pump 122. Each of the modules 102 downstream of the has a feed line 104 that is coupled between an inlet of the feed chamber 124 of the module 102 and an outlet of the feed chamber 124 of the preceding module 102. The outlet of the feed chamber 124 of the last module 102 in the series is coupled to the liquid feed tank 120 by the feed return line 110.

As the concentration of the liquid feed increases through the sequential arrangement of the modules 102, the membrane 132 may be adjusted in downstream modules 102 to increase the amount of vapor transferred from the feed chamber 124 to the vacuum chamber 126. The sequential arrangement of the liquid feed may lower the energy demands of the MS-VMD system 154, as the energy input to modules 102 that are upstream may lower the energy needed for modules 102 that are downstream.

FIG. 1J is a simplified process flow diagram of a MS-VMD system 156 that uses the condenser 114 for the vapor from the vacuum line 108 and the carrier gas condenser 138 for the gas from the carrier gas outlet line 112, wherein the modules 102 are coupled in parallel to the carrier gas line 106 and the vacuum line 108, but are coupled in series to the feed line 104. In this embodiment, the feed line 104 is coupled to an inlet on the feed chamber 124 for the first module 102 downstream of the pump 122. Each of the modules 102 downstream of the has a feed line 104 that is coupled between an inlet of the feed chamber 124 of the module 102 and an outlet of the feed chamber 124 of the preceding module 102. The outlet of the feed chamber 124 of the last module 102 in the series is coupled to the liquid feed tank 120 by the feed return line 110.

FIG. 1K is a simplified process flow diagram of a MS-VMD system 158 that uses the condenser 114 for the vapor from the vacuum line 108 and the gas from the carrier gas outlet line 112, wherein the modules 102 are coupled in parallel to the carrier gas line 106, but are coupled in series to the feed line 104 and the vacuum line 108. In this embodiment, the feed line 104 is coupled to an inlet on the feed chamber 124 for the first module 102 downstream of the pump 122. Each of the modules 102 downstream of the has a feed line 104 that is coupled between an inlet of the feed chamber 124 of the module 102 and an outlet of the feed chamber 124 of the preceding module 102. The outlet of the feed chamber 124 of the last module 102 in the series is coupled to the liquid feed tank 120 by the feed return line 110. Further, the vacuum line 108 is coupled to each vacuum chamber 126 through a first port, then to the next vacuum chamber through a second port. The last vacuum chamber 126 in the series is coupled to the condenser 114.

FIG. 1L is a simplified process flow diagram of a MS-VMD system 160 that that uses the condenser 114 for the vapor from the vacuum line 108 and the carrier gas condenser 138 for the gas from the carrier gas outlet line 112, wherein the modules 102 are coupled in parallel to the carrier gas line 106, but are coupled in series to the feed line 104 and the vacuum line 108. In this embodiment, the feed line 104 is coupled to an inlet on the feed chamber 124 for the first module 102 downstream of the pump 122. Each of the modules 102 downstream of the has a feed line 104 that is coupled between an inlet of the feed chamber 124 of the module 102 and an outlet of the feed chamber 124 of the preceding module 102. The outlet of the feed chamber 124 of the last module 102 in the series is coupled to the liquid feed tank 120 by the feed return line 110. Further, the vacuum line 108 is coupled to each vacuum chamber 126 through a first port, then to the next vacuum chamber through a second port. The last vacuum chamber 126 in the series is coupled to the condenser 114.

FIG. 1M is a simplified process flow diagram of a MS-VMD system 162 that that uses the condenser 114 for the vapor from the vacuum line 108 and the gas from the carrier gas outlet line 112, wherein the modules 102 are coupled in parallel to the vacuum line 108, but are coupled in series to the carrier gas line 106 and the feed line 104.

In this embodiment, the carrier gas line 106 from the blower 131 is coupled to an inlet on the feed chamber 124 of the first module 102 downstream of the blower 131. Each of the modules 102 downstream of that has a carrier gas line 106 coupled to an inlet of the feed chamber 124 of the module 102 that is coupled to an outlet of the feed chamber 124 of the preceding module 102. The carrier gas outlet line 112 from the feed chamber 124 of the last of the modules 102 in the sequence is coupled to the condenser 114. Further, the feed line 104 is coupled to an inlet on the feed chamber 124 for the first module 102 downstream of the pump 122. Each of the modules 102 downstream of the has a feed line 104 that is coupled between an inlet of the feed chamber 124 of the module 102 and an outlet of the feed chamber 124 of the preceding module 102. The outlet of the feed chamber 124 of the last module 102 in the series is coupled to the liquid feed tank 120 by the feed return line 110.

FIG. 1N is a simplified process flow diagram of a MS-VMD system 164 that that uses the condenser 114 for the vapor from the vacuum line 108 and the carrier gas condenser 138 for the gas from the carrier gas outlet line 112, wherein the modules 102 are coupled in parallel to the vacuum line 108, but are coupled in series to the carrier gas line 106 and the feed line 104.

In this embodiment, the carrier gas line 106 from the blower 131 is coupled to an inlet on the feed chamber 124 of the first module 102 downstream of the blower 131. Each of the modules 102 downstream of that has a carrier gas line 106 coupled to an inlet of the feed chamber 124 of the module 102 that is coupled to an outlet of the feed chamber 124 of the preceding module 102. The carrier gas outlet line 112 from the feed chamber 124 of the last of the modules 102 in the sequence is coupled to the carrier gas condenser 138. Further, the feed line 104 is coupled to an inlet on the feed chamber 124 for the first module 102 downstream of the pump 122. Each of the modules 102 downstream of the has a feed line 104 that is coupled between an inlet of the feed chamber 124 of the module 102 and an outlet of the feed chamber 124 of the preceding module 102. The outlet of the feed chamber 124 of the last module 102 in the series is coupled to the liquid feed tank 120 by the feed return line 110.

FIG. 1O is a simplified process flow diagram of a MS-VMD system 166 that that uses the condenser 114 for the vapor from the vacuum line 108 and the gas from the carrier gas outlet line 112, wherein the modules 102 are coupled in series to the vacuum line 108, the carrier gas line 106, and the feed line 104.

In this embodiment, the vacuum line 108 is coupled to each vacuum chamber 126 through a first port, then to the next vacuum chamber through a second port. The last vacuum chamber 126 in the series is coupled to the condenser 114. the carrier gas line 106 from the blower 131 is coupled to an inlet on the feed chamber 124 of the first module 102 downstream of the blower 131. Each of the modules 102 downstream of that has a carrier gas line 106 coupled to an inlet of the feed chamber 124 of the module 102 that is coupled to an outlet of the feed chamber 124 of the preceding module 102. The carrier gas outlet line 112 from the feed chamber 124 of the last of the modules 102 in the sequence is coupled to the condenser 114. Further, the feed line 104 is coupled to an inlet on the feed chamber 124 for the first module 102 downstream of the pump 122. Each of the modules 102 downstream of the has a feed line 104 that is coupled between an inlet of the feed chamber 124 of the module 102 and an outlet of the feed chamber 124 of the preceding module 102. The outlet of the feed chamber 124 of the last module 102 in the series is coupled to the liquid feed tank 120 by the feed return line 110.

FIG. 1P is a simplified process flow diagram of a MS-VMD system 168 that that uses the condenser 114 for the vapor from the vacuum line 108 and the carrier gas condenser 138 for the gas from the carrier gas outlet line 112, wherein the modules 102 are coupled in series to the vacuum line 108, the carrier gas line 106, and the feed line 104.

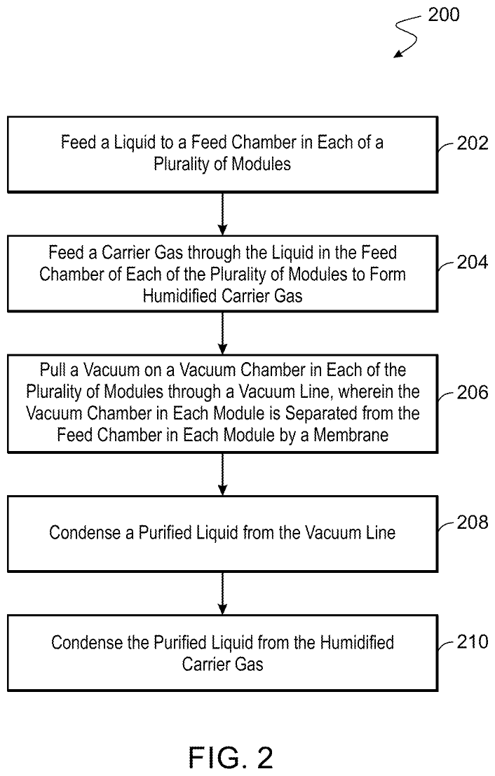

FIG. 2 is a process flow diagram of a method 200 for purifying a liquid feed using a MS-VMD system. The method 200 begins at block 202 when a liquid is fed to a feed chamber in each of a plurality of modules. The liquid in the feed chamber is at a temperature of greater than about 50° C. The liquid can be heated before it is fed to the feed chamber or the liquid can be heated in the feed chamber. In some embodiments, the liquid is fed to a feed chamber of a first module of the plurality of modules, and the liquid exiting the feed chamber of the first module of the plurality of modules is then fed to a feed chamber of a second module of the plurality of modules.

At block 204, feed a carrier gas through the liquid in the feed chamber of each of the plurality of modules to form humidified carrier gas. In some embodiments, the carrier gas is fed to a feed chamber of a first module of the plurality of modules, and then the carrier gas exiting the feed chamber of the first module of the plurality of modules is fed to a feed chamber of a second module of the plurality of modules.

At block 206, a vacuum is pulled on a vacuum chamber in each of the plurality of modules through a vacuum line, wherein the vacuum chamber in each module is separated from the feed chamber in each module by a membrane, and wherein the membrane allows vapor to pass across the membrane while blocking liquid flow across the membrane. In some embodiments, the vacuum is pulled on a vacuum chamber of a first module of the plurality of modules, and then a vacuum is pulled on a vacuum chamber of a second module of the plurality of modules from the vacuum chamber of the first module of the plurality of modules.

At block 208, a purified liquid is condensed from the vacuum line. At block 210, the purified liquid is condensed from the humidified carrier gas.

The details of one or more implementations of the subject matter of this disclosure are set forth in the accompanying drawings and the description. Other features, aspects, and advantages of the subject matter will become apparent from the description, the drawings, and the claims.

### Embodiments

In an embodiment described by example herein, a multistage vacuum membrane distillation (MS-VMD) system including a plurality of modules is provided. The MS-VMD system includes a feed chamber coupled to a feed line and a carrier gas line, wherein the feed line introduces a liquid feed into the feed chamber from a liquid feed tank, and wherein the carrier gas line introduces a carrier gas into the feed chamber. The MS-VMD system also includes a vacuum chamber coupled to a vacuum line, wherein the vacuum line pulls a vacuum on the vacuum chamber, and a membrane separating the feed chamber from the vacuum chamber, wherein the membrane allows transportation of vapor from the feed chamber to the vacuum chamber while blocking liquid from moving from the feed chamber to the vacuum chamber.

In an aspect, the MS-VMD system further includes a condenser fluidically coupled to the vacuum line, wherein the condenser condenses the vapor to form a purified distillate.

In an aspect, the MS-VMD system further includes a vacuum pump fluidically coupled to the condenser, wherein the vacuum pump pulls the vacuum on the condenser and, through the condenser, the vacuum line.

In an aspect, the MS-VMD system further includes a carrier gas outlet line fluidically coupling a carrier gas outlet on the feed chamber to the condenser.

In an aspect, the MS-VMD system further includes a carrier gas condenser fluidically coupled to a carrier gas outlet line that is fluidically coupled to a carrier gas outlet on the feed chamber.

In an aspect, the plurality of modules are coupled in parallel to the feed line, the carrier gas line, and the vacuum line.

In an aspect, the plurality of modules are fluidically coupling in series to the liquid feed, wherein a liquid input to the feed chamber of a first module in the series is fluidically coupled to the feed line, a liquid outlet of the feed chamber of a last module in the series is fluidically coupled to a feed return line, and each intervening module between the first module and the last module is fluidically coupled by line from a liquid outlet on the feed chamber of the intervening module to a liquid inlet on the feed chamber of the next module.

In an aspect, the plurality of modules are fluidically coupled in series to the vacuum, wherein a vacuum line of the vacuum chamber of a first module in the series is fluidically coupled to the vacuum line, a vacuum line of the vacuum chamber of a last module in the series is fluidically coupled to a line from a vacuum outlet on an intervening module, and each intervening module between the first module and the last module is fluidically coupled by a line from a vacuum outlet of the feed chamber of the intervening module to a vacuum inlet of the vacuum chamber of the next module.

In an aspect, the plurality of modules are fluidically coupled in series to the carrier gas, wherein a carrier gas inlet the feed chamber of a first module in the series is fluidically coupled to the carrier gas line, a carrier gas outlet of the feed chamber of a last module in the series is fluidically coupled to a carrier gas outlet line, and each intervening module between the first module and the last module is fluidically coupled by line from the gas outlet of the feed chamber of the intervening module to a gas inlet of the feed chamber of the next module.

In an aspect, the MS-VMD system further includes a heating element in a liquid feed tank, a heat exchanger on the feed line, or both.

In an aspect, the MS-VMD system further includes a a heating element disposed in a feed chamber of a module.

In an aspect, the liquid feed includes an aqueous solution.

In an aspect, the liquid feed includes a liquid including a dissolved salt, a mixture of salts, a salt and an organic contaminant mixture, or a salt and an inorganic contaminant mixture, or any combinations thereof.

In an aspect, the liquid feed includes seawater, industrial wastewater, brackish water, produced water, fruit juice, blood, milk, dye, hazardous-waste water, or a brine solution, or any combinations thereof.

In an aspect, the membrane includes a composite membrane, a nano-composite membrane, a hydrophobic membrane, an omniphobic membrane, a hydrophilic and hydrophobic composite dual layer membrane, a modified ceramic membrane, a porous ceramic membrane, a surface modified membrane, a polymer electrolyte membrane, a porous graphene membrane, or a polymeric membrane, or any combinations thereof.

In an aspect, the membrane includes a reinforced hollow tube, a non-reinforced hollow tube, a spiral wound 2, a flat sheet, or a non-flat sheet, or any combinations thereof.

In an aspect, a contact angle of a droplet of the liquid feed on the membrane is greater than 90° (degrees).

In an aspect, the carrier gas includes air, nitrogen, helium, argon, or carbon dioxide, or any combinations thereof.

Another embodiment described by example herein provides a method for purifying a liquid using a multi-stage vacuum membrane distillation (MS-VMD) system. The method includes feeding a liquid to a feed chamber in each of a plurality of modules, wherein the liquid in the feed chamber is at a temperature of greater than about 50° C. A carrier gas is fed through the liquid in the feed chamber of each of the plurality of modules to form humidified carrier gas. A vacuum is pulled on a vacuum chamber in each of the plurality of modules through a vacuum line, wherein the vacuum chamber in each module is separated from the feed chamber in each module by a membrane, and wherein the membrane allows vapor to pass across the membrane while blocking liquid flow across the membrane. A purified liquid is condensed from the vacuum line. The purified liquid is condensed from the humidified carrier gas.

In an aspect, the method further includes heating the liquid before feeding the liquid to the feed chamber.

In an aspect, the method further includes heating the liquid in the feed chamber.

In an aspect, the method further includes feeding the liquid to a feed chamber of a first module of the plurality of modules, then feeding the liquid exiting the feed chamber of the first module of the plurality of modules to a second module of the plurality of modules.

In an aspect, the method further includes pulling the vacuum on a vacuum chamber of a first module of the plurality of modules, then pulling the vacuum on a second module of the plurality of modules from the vacuum chamber of the first module of the plurality of modules.

In an aspect, the method further includes feeding the carrier gas through a feed chamber of a first module of the plurality of modules, then feeding the carrier gas exiting the feed chamber of the first module of the plurality of modules to a feed chamber of a second module of the plurality of modules.

Other implementations are also within the scope of the following claims.

What is claimed is:

1. A multistage vacuum membrane distillation (MS-VMD) system comprising a plurality of modules, wherein each module comprises:
a feed chamber coupled to a feed line and a carrier gas line, wherein the feed line introduces a liquid feed into the feed chamber from a liquid feed tank, and wherein the carrier gas line introduces a carrier gas into the feed chamber;
a vacuum chamber coupled to a vacuum line, wherein the vacuum line pulls a vacuum on the vacuum chamber; and
a membrane separating the feed chamber from the vacuum chamber, wherein the membrane allows transportation of vapor from the feed chamber to the vacuum chamber while blocking liquid from moving from the feed chamber to the vacuum chamber.

2. The MS-VMD system of claim 1, further comprising a condenser fluidically coupled to the vacuum line, wherein the condenser condenses the vapor to form a purified distillate.

3. The MS-VMD system of claim 2, further comprising a vacuum pump fluidically coupled to the condenser, wherein the vacuum pump pulls the vacuum on the condenser and, through the condenser, the vacuum line.

4. The MS-VMD system of claim 2, further comprising a carrier gas outlet line fluidically coupling a carrier gas outlet on the feed chamber to the condenser.

5. The MS-VMD system of claim 1, further comprising a carrier gas condenser fluidically coupled to a carrier gas outlet line that is fluidically coupled to a carrier gas outlet on the feed chamber.

6. The MS-VMD system of claim 1, wherein the plurality of modules are coupled in parallel to the feed line, the carrier gas line, and the vacuum line.

7. The MS-VMD system of claim 1, wherein the plurality of modules are fluidically coupling in series to the liquid feed, wherein a liquid input to the feed chamber of a first module in the series is fluidically coupled to the feed line, a liquid outlet of the feed chamber of a last module in the series is fluidically coupled to a feed return line, and each intervening module between the first module and the last module is fluidically coupled by line from a liquid outlet on the feed chamber of the intervening module to a liquid inlet on the feed chamber of the next module.

8. The MS-VMD system of claim 1, wherein the plurality of modules are fluidically coupled in series to the vacuum, wherein a vacuum line of the vacuum chamber of a first module in the series is fluidically coupled to the vacuum line, a vacuum line of the vacuum chamber of a last module in the series is fluidically coupled to a line from a vacuum outlet on an intervening module, and each intervening module between the first module and the last module is fluidically coupled by a line from a vacuum outlet of the feed chamber of the intervening module to a vacuum inlet of the vacuum chamber of the next module.

9. The MS-VMD system of claim 1, wherein the plurality of modules are fluidically coupled in series to the carrier gas, wherein a carrier gas inlet the feed chamber of a first module in the series is fluidically coupled to the carrier gas line, a carrier gas outlet of the feed chamber of a last module in the series is fluidically coupled to a carrier gas outlet line, and each intervening module between the first module and the last module is fluidically coupled by line from the gas outlet of the feed chamber of the intervening module to a gas inlet of the feed chamber of the next module.

10. The MS-VMD system of claim 1, comprising a heating element in a liquid feed tank, a heat exchanger on the feed line, or both.

11. The MS-VMD system of claim 1, comprising a heating element disposed in a feed chamber of a module.

12. The MS-VMD system of claim 1, wherein the liquid feed comprises an aqueous solution.

13. The MS-VMD system of claim 1, wherein the liquid feed comprises a liquid including a dissolved salt, a mixture of salts, a salt and an organic contaminant mixture, or a salt and an inorganic contaminant mixture, or any combinations thereof.

14. The MS-VMD system of claim 1, wherein the liquid feed comprises seawater, industrial wastewater, brackish water, produced water, fruit juice, blood, milk, dye, hazardous-waste water, or a brine solution, or any combinations thereof.

15. The MS-VMD system of claim 1, wherein the membrane comprises a composite membrane, a nano-composite membrane, a hydrophobic membrane, an omniphobic membrane, a hydrophilic and hydrophobic composite dual layer membrane, a modified ceramic membrane, a porous ceramic membrane, a surface modified membrane, a polymer electrolyte membrane, a porous graphene membrane, or a polymeric membrane, or any combinations thereof.

16. The MS-VMD system of claim 1, wherein the membrane comprises a reinforced hollow tube, a non-reinforced hollow tube, a spiral wound 2, a flat sheet, or a non-flat sheet, or any combinations thereof.

17. The MS-VMD system of claim 1, wherein a contact angle of a droplet of the liquid feed on the membrane is greater than 90° (degrees).

18. The MS-VMD system of claim 1, wherein the carrier gas comprises air, nitrogen, helium, argon, or carbon dioxide, or any combinations thereof.

19. A method for purifying a liquid using a multi-stage vacuum membrane distillation (MS-VMD) system, comprising:
feeding a liquid to a feed chamber in each of a plurality of modules, wherein the liquid in the feed chamber is at a temperature of greater than about 50° C.;
feeding a carrier gas through the liquid in the feed chamber of each of the plurality of modules to form humidified carrier gas;
pulling a vacuum on a vacuum chamber in each of the plurality of modules through a vacuum line, wherein the vacuum chamber in each module is separated from the feed chamber in each module by a membrane, and
wherein the membrane allows vapor to pass across the membrane while blocking liquid flow across the membrane;
condensing purified liquid from the vacuum line; and
condensing purified liquid from the humidified carrier gas.

20. The method of claim 19, comprising heating the liquid before feeding the liquid to the feed chamber.

21. The method of claim 19, comprising heating the liquid in the feed chamber.

22. The method of claim 19, comprising feeding the liquid to a feed chamber of a first module of the plurality of modules, then feeding the liquid exiting the feed chamber of the first module of the plurality of modules to a second module of the plurality of modules.

23. The method of claim 19, comprising pulling the vacuum on a vacuum chamber of a first module of the plurality of modules, then pulling the vacuum on a second module of the plurality of modules from the vacuum chamber of the first module of the plurality of modules.

24. The method of claim 19, comprising feeding the carrier gas through a feed chamber of a first module of the plurality of modules, then feeding the carrier gas exiting the feed chamber of the first module of the plurality of modules to a feed chamber of a second module of the plurality of modules.
